(19) United States
(12) Patent Application Publication
(10) Pub. No.: US 2024/0079791 A1
(43) Pub. Date: Mar. 7, 2024

(54) Electromagnetic Wave Director

(71) Applicant: Meta Materials Inc., North Billerica, MA (US)

(72) Inventors: Ragip Pala, Pleasanton, CA (US); Jonathan Waldern, Los Altos Hills, CA (US); Efthymios Kallos, London (GB); Milan Momcilo Popovich, Leicester (GB); George Palikaras, Dartmouth (CA)

(21) Appl. No.: 18/244,196

(22) Filed: Sep. 8, 2023

Related U.S. Application Data
(63) Continuation-in-part of application No. PCT/EP2022/055946, filed on Mar. 8, 2022.

(30) Foreign Application Priority Data
Mar. 8, 2021 (GB) 2103220.6
Mar. 8, 2022 (WO) PCT/EP2022/055946

(51) Int. Cl. H01Q 15/00; H01Q 19/10

(52) U.S. Cl. CPC H01Q 15/0086; H01Q 19/10

(57) ABSTRACT

There is provided an electromagnetic wave director comprising a substrate supporting a diffractive element formed from a two-dimensional array of subwavelength subcells deposited onto said substrate, said diffractive element operative to direct an electromagnetic wave signal generated by at least one electromagnetic wave transmitter to at least one electromagnetic receiver disposed within at least one coverage zone lying outside the line of sight of the transmitter, said diffractive element having metasurface prescription for modifying the amplitude and phase of incident electromagnetic wavefronts on each subwavelength subcell. There is also provided associated systems and methods.

### CROSS REFERENCE TO RELATED APPLICATION

This application is filed under 35 U.S.C. § 111(a) and is based on and hereby claims priority under 35 U.S.C. § 120 and § 365(c) from International Application No. PCT/EP2022/055946, filed on Mar. 8, 2022, and published as WO 2022/189460 A1 on Sep. 15, 2022, which in turn claims priority from Great Britain Application No. 2103220.6, filed in the United Kingdom on Mar. 8, 2021. This application is a continuation-in-part of International Application No. PCT/EP2022/055946, which is a continuation of Great Britain Application No. 2103220.6. International Application No. PCT/EP2022/055946 is pending as of the filing date of this application, and the United States is an elected state in International Application No. PCT/EP2022/055946. This application claims the benefit under 35 U.S.C. § 119 from Great Britain Application No. 2103220.6. The disclosure of each of the foregoing documents is incorporated herein by reference.

### TECHNICAL FIELD

The present disclosure relates to electromagnetic wave communications systems and more particularly to a diffractive electromagnetic wave director.

### BACKGROUND

Millimeter waves can provide the spectral bandwidths and support the high data rates needed for future 5G/6G systems. However, severe free space losses, atmospheric absorption and scatter can limit millimeter wave coverage in urban environments. Phased-array radar with electronic beam-steering capabilities permit the use of highly directional millimeter wave transmission and reception through non-line-of-sight paths, but tend to be complex and expensive to manufacture. On the other hand, typical reflectors based on curved surfaces suffer from limited angular bandwidths, bulk and high manufacturing costs. Reflector arrays combining several such elements offer only marginal improvements in angular coverage.

### SUMMARY

We disclose an improved electromagnetic wave director that can be applied to frequencies across the electromagnetic spectrum and can be configured for reflection or transmission.

In an aspect, there is provided an electromagnetic wave director comprising a substrate supporting a diffractive element formed from a two-dimensional array of subwavelength subcells deposited onto said substrate, said diffractive element operative to direct an electromagnetic wave signal generated by at least one electromagnetic wave transmitter to at least one electromagnetic receiver disposed within at least one coverage zone lying outside the line of sight of the transmitter, said diffractive element having metasurface prescription for modifying the amplitude and phase of incident electromagnetic wavefronts on each subwavelength subcell.

In an aspect, there is provided a system for modifying the amplitude and phase of incident electromagnetic wave wavefronts, comprising at least one electromagnetic wave transmitter; at least one electromagnetic wave receiver disposed within at least one coverage zone lying outside the line of sight of the transmitter; and an electromagnetic wave director comprising a substrate supporting a diffractive element formed from a two-dimensional array of subwavelength subcells deposited onto said substrate. Said diffractive element is operative to direct an electromagnetic wave signal generated by said at least one electromagnetic wave transmitter to said at least one electromagnetic wave receiver. The transmitter is configured to transmit the electromagnetic wave signal to the electromagnetic wave director. The electromagnetic wave director is configured to modify the amplitude and phase of incident electromagnetic wave wavefronts of the electromagnetic wave signal. Operative to direct the electromagnetic wave signal, electromagnetic wave director is configured to reflect the electromagnetic wave, to transmit the electromagnetic wave, or partially reflect and partially transmit. The diffractive element may have a metasurface prescription for modifying the amplitude and phase of incident electromagnetic wavefronts on each subwavelength subcell.

In an aspect, there is provided a method of modifying the amplitude and phase of incident electromagnetic wave wavefronts, comprising: providing an electromagnetic wave director comprising a substrate supporting a diffractive element formed from a two-dimensional array of subwavelength subcells deposited onto said substrate, said diffractive element operative to direct a first electromagnetic wave signal generated by at least one electromagnetic wave transmitter to at least one electromagnetic wave receiver disposed within at least one coverage zone lying outside the line of sight of the transmitter; receiving, at the electromagnetic wave director, the first electromagnetic wave signal from the at least one electromagnetic wave transmitter; diffracting, from the electromagnetic wave director, towards said at least one coverage zone, a second electromagnetic wave signal, wherein the second electromagnetic wave signal has a different amplitude and phase to the first electromagnetic wave signal. The diffracting may comprise reflecting and/or transmitting the first electromagnetic wave signal to become the diffracted second electromagnetic wave signal. The diffractive element may have a metasurface prescription for modifying the amplitude and phase of incident electromagnetic wavefronts on each subwavelength subcell.

In the above aspects, the electromagnetic waves may be millimeter waves, and the electromagnetic wave signals may be millimeter wave signals. A millimeter wave signal has a wavelength of at least one millimeter. The electromagnetic wave director may be a millimeter wave reflector.

Some embodiments to be discussed are directed at a millimeter wave reflector based on thin lightweight diffracting structures that can provide an efficient and cost-effective solution for increasing millimeter wave communications coverage by directing millimeter waves into regions lying outside the line of sight of the transmitter. We also disclose an efficient and low-cost process for manufacturing millimeter wave reflectors using low-cost materials. Millimeter wave diffractive structures offer a more compact and cost-effective solution to problems present in the field.

Various embodiments of the millimeter wave reflector can incorporate one or more of the following features described in the following paragraphs.

In various embodiments, a millimeter wave reflector comprises a substrate supporting a diffractive nanostructure formed from a two-dimensional mesh of continuous metal wires deposited onto said substrate. The diffractive nanostructure is operative to reflect a millimeter wave signal generated by at least one millimeter wave transmitter to at least one millimeter wave receiver disposed within at least one coverage zone lying outside the line of sight of the transmitter. The diffractive nanostructures have an optical prescription for modifying the amplitude and phase of incident millimeter wavefronts.

In some embodiments, the substrate can be glass or plastic.

In some embodiments, the reflector can be configured as a film for mounting on the wall of a building.

In some embodiments, the reflector can be configured to adjust the boresight vector of a millimeter wave beam.

In some embodiments, the reflector can be configured as a film for mounting on a window to provide transmission in the optical wave band and reflection in millimeter wave band.

In some embodiments, the reflector is an element of a set of reflectors configured with a set of transmit antennas to provide a phased array system.

In some embodiments, the reflector is an element of a multiple input multiple output (MIMO) antenna system.

In some embodiments, the reflector incorporates light sensitive elements and light attenuating structures for enabling dimming of visible band light transmitted through said reflector.

In some embodiments, the reflector is an element of a plurality of reflectors that can compensate each other aberrations.

In some embodiments, the reflector is an element of a plurality of reflectors providing a folded millimeter wave communications path.

In some embodiments, the reflector is configured to reflect millimeter waves into a plurality of coverage zones.

In some embodiments, the reflector is configured to provide a plurality of transmitter-to-receiver paths in a plurality of coverage zones.

In some embodiments, the reflector includes diffracting structures for enabling at least one of frequency diversity, angle diversity, and polarization diversity, where the term diversity refers the ability of the reflector to perform its function for a range of different frequencies, a range of different angles and a range of different polarizations.

In some embodiments, the reflector can employ a metasurface configured as a Huygens surface for controlling at least one selected from the group of reflection, beam steering, and polarization.

In some embodiments, the reflector comprises an array of reflecting elements.

In some embodiments, the diffractive nanostructure used in the millimeter wave reflector can be fabricated using a RML process combined with a VPD process.

In some embodiments, the diffractive nanostructure used in the millimeter wave reflector can provide EMI shielding.

Following below are more detailed descriptions of various concepts related to, and embodiments of, an inventive millimeter wave reflector and processes for manufacturing it. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. A more complete understanding of the invention can be obtained by considering the following detailed description in conjunction with the accompanying drawings, wherein like index numerals indicate like parts. For purposes of clarity, details relating to technical material that is known in the technical fields related to the invention have not been described in detail.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A conceptually illustrates a millimeter wave reflector in accordance with an embodiment of the invention.

FIG. 1B conceptually illustrates a millimeter wave reflector transmitting a portion of an incident beam in accordance with an embodiment of the invention.

FIG. 2 conceptually illustrates a millimeter wave reflector in accordance with an embodiment of the invention.

FIG. 3 conceptually illustrates the formation of a folded communications path using two millimeter wave reflectors.

FIG. 4 conceptually illustrates a millimeter wave reflector with optical power in accordance with an embodiment of the invention.

FIG. 5 conceptually illustrates a millimeter wave reflector for enabling communication between more than one transmitter and more than one receiver in accordance with an embodiment of the invention.

FIG. 6 conceptually illustrates concentric phase fronts formed by a diffractive structure encoding optical power formed on a surface of the reflector substrate in accordance with an embodiment of the invention.

FIG. 7 conceptually illustrates a set of phase fronts formed by a 2×2 array of reflectors, each reflector element being designed to reflect millimeter waves from one or more transmitters into a unique coverage zone in accordance with an embodiment of the invention.

FIG. 8 conceptually illustrates a set of phase fronts each corresponding to a unique beam direction and angular bandwidth formed by a reflector comprising multiplexed diffraction structures in accordance with an embodiment of the invention.

FIG. 9 conceptually illustrated a millimeter wave reflector in accordance with an embodiment of the invention.

FIG. 10 conceptually illustrates a cylindrical photomask for printing diffractive structures for use in a millimeter wave reflector in accordance with an embodiment of the invention.

FIG. 11A conceptually illustrates a first configuration of a diffractive element comprising an array of diffractive subcells in accordance with an embodiment of the invention.

FIG. 11B conceptually illustrates a second configuration of a diffractive element comprising an array of diffractive subcells in accordance with an embodiment of the invention.

FIG. 11C conceptually illustrates a third configuration of a diffractive element comprising an array of diffractive subcells in accordance with an embodiment of the invention.

FIG. 12 shows a method for modifying the amplitude and phase of incident electromagnetic wave wavefronts in accordance with an embodiment of the invention.

FIG. 13 is a chart illustrating multi-band operation provided by a reflector in accordance with an embodiment of the invention.

### DETAILED DESCRIPTION

Reference will now be made in detail to some embodiments of the invention, examples of which are illustrated in the accompanying drawings.

Various embodiments of a millimeter wave reflector are described by way of example with reference to the accompanying drawings. It will apparent to those skilled in the art that the present invention may be practiced with some or all of the present invention as disclosed in the following description. For the purposes of explaining the invention, well-known features of optical technology known to those skilled in the art of optical design and visual displays have been omitted or simplified in order not to obscure the basic principles of the invention. In the following description the terms light, ray, beam and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. It should also be noted that in the following description of the invention repeated usage of the phrase “in one embodiment” does not necessarily refer to the same embodiment. As used herein, the term “grating” may encompass a grating comprised of a set of gratings in some embodiments.

An object of the invention is achieved in a first embodiment in which there is provided a millimeter wave reflector for reflecting a signal emitted by at least one millimeter wave transmitter into at least one coverage zone lying outside the line of sight of the transmitter within which the signal can be detected by one or more millimeter wave receivers. The reflector comprises a substrate supporting a diffractive element configured to diffract millimeter waves. As will be discussed in more detail below, the diffractive element is formed from a two-dimensional array of subwavelength subcells deposited onto the substrate. The diffractive element has a metasurface prescription for modifying the amplitude and phase of incident millimeter wavefronts on each subwavelength subcell. The term “metasurface prescription” refers to the specification of optical parameters that determine the amplitude and phase of diffracted light, the key parameters being the spatial frequencies of diffracting features, dielectric constants, surface modulation and birefringence. The millimeter wave reflector enables control over angular bandwidth and reflection. In further embodiments the millimeter wave reflector can operate in a transmission mode. In some embodiments, the apparatus comprises the diffracting elements formed from subwavelength subs cells and a back reflector sandwiching a spacer.

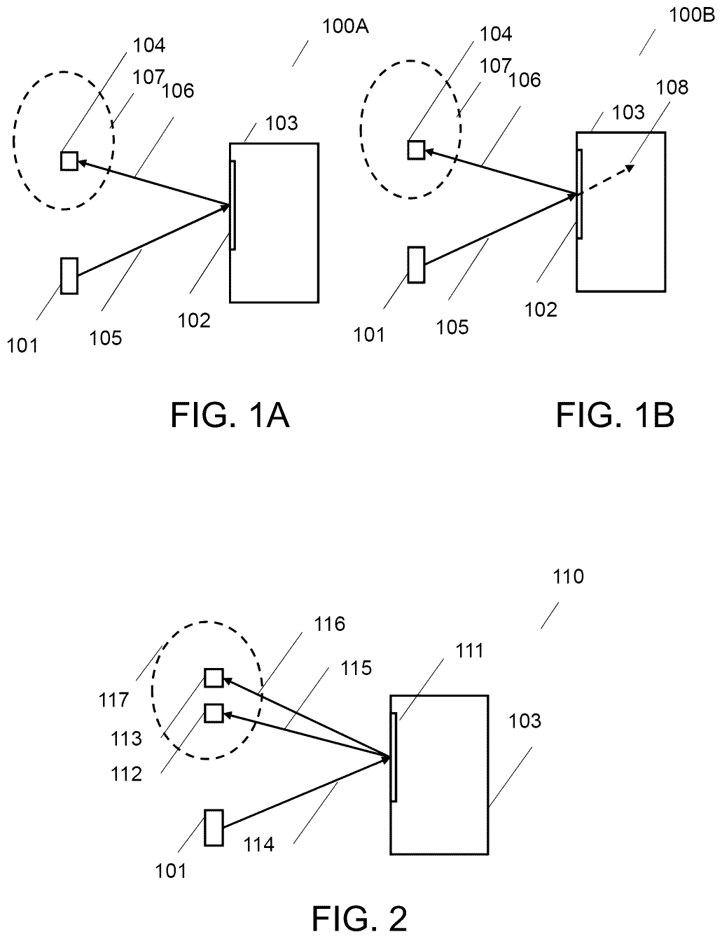

The object of the invention is achieved in a first embodiment (100) conceptually illustrated in FIG. 1A. In FIG. 1A, a transmitter (101) emits a millimeter wave beam that is reflected by a reflector (102) mounted on an external wall or window of a building (103) into a signal coverage zone (107) containing at least one receiver (104). The beam paths from the transmitter to the reflector and the reflected beam path from the reflector to the receiver are represented schematically by two rays (105,106). In some embodiments, the reflector can be mounted on an exterior wall of a building or some other outdoor fixed installation. In some embodiments, reflector can be mounted on an interior wall of the building. In some embodiments, the reflector can be mounted on a movable installation or on a vehicle. In some embodiments, the receiver can be mounted on a vehicle or on a handheld communications device. The diffractive structures can be formed in metals or dielectric materials or composites of the two. In some embodiments, the reflector can be configured to transmit at least part of the incident beam through the substrate towards a receiver inside the building or a vehicle. FIG. 1B conceptually illustrates the transmission of a portion (108) of the incident millimeter wave through the substrate

As conceptually illustrated in FIG. 2, the reflected signal can be detected by more than one receiver. FIG. 2 shows two receivers operating in the reflection zone (117) of a reflector (111). The ray paths from the transmitter to the reflector and from the reflector to the receivers are represented by rays 114-116. In some embodiments, more than one reflector can be used to steer a millimeter waves through an environment containing obstacles that might otherwise block the beam.

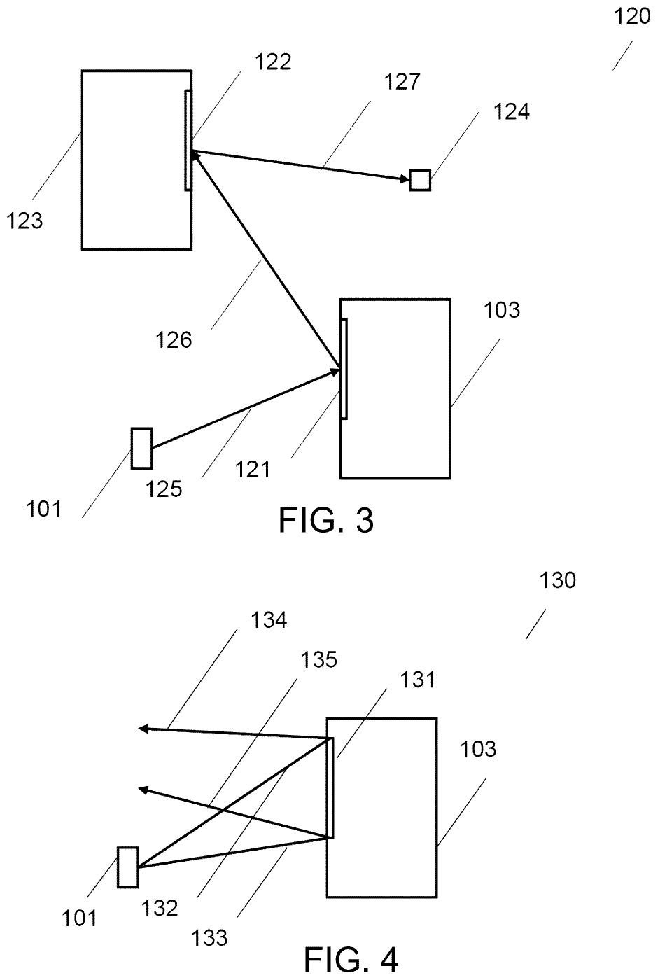

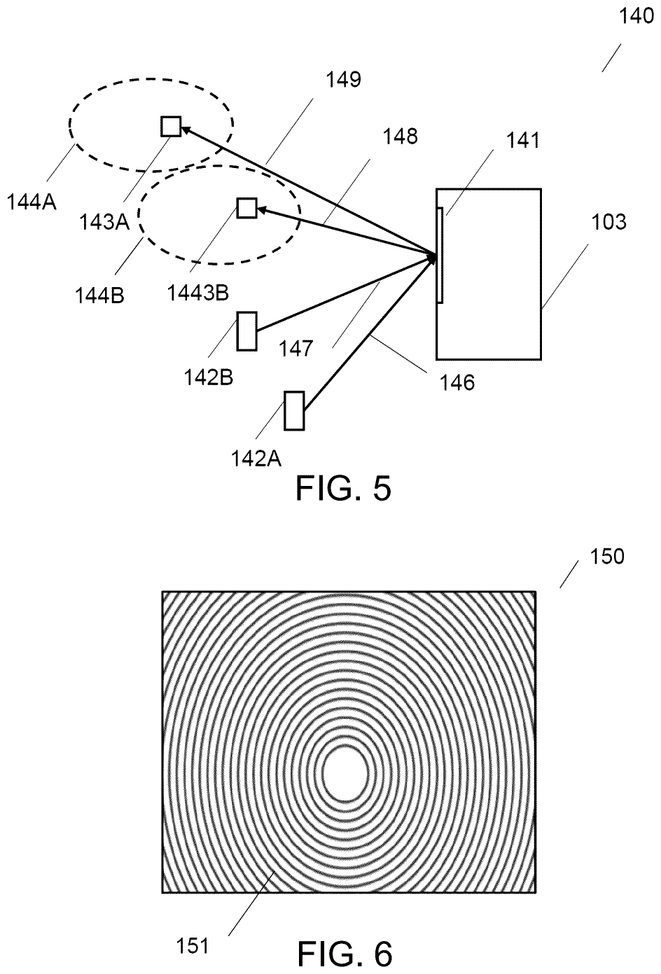

FIG. 3 shows a millimeter wave communications network (120) that includes reflectors (121,122) mounted on two buildings (103,123) configured to direct millimeter waves from a transmitter to a receiver (124) along a folded beam path (125-127). In some embodiments, the reflector according to the principles of the invention can have lens power for focusing (or diverging) a millimeter beam. FIG. 4 conceptually illustrates an embodiment (130) that includes a reflector for reflecting and focusing the divergent beam (132,133) from the transmitter (101) into a convergent beam (134). In some embodiments, the reflector can be configured to adjust the boresight vector of a millimeter wave beam. In some embodiments, a reflector can be used to reflect light from one or more transmitters into one or more coverage zones. FIG. 5 conceptually illustrates an embodiment in which a reflector 141 reflects millimeter waves from a first transmitter (142A) into a first coverage zone (144A) for detection by a first receiver (143A) and reflects millimeter waves from a second transmitter (142B) into a second coverage zone (144B) for detection by a second receiver (143B).

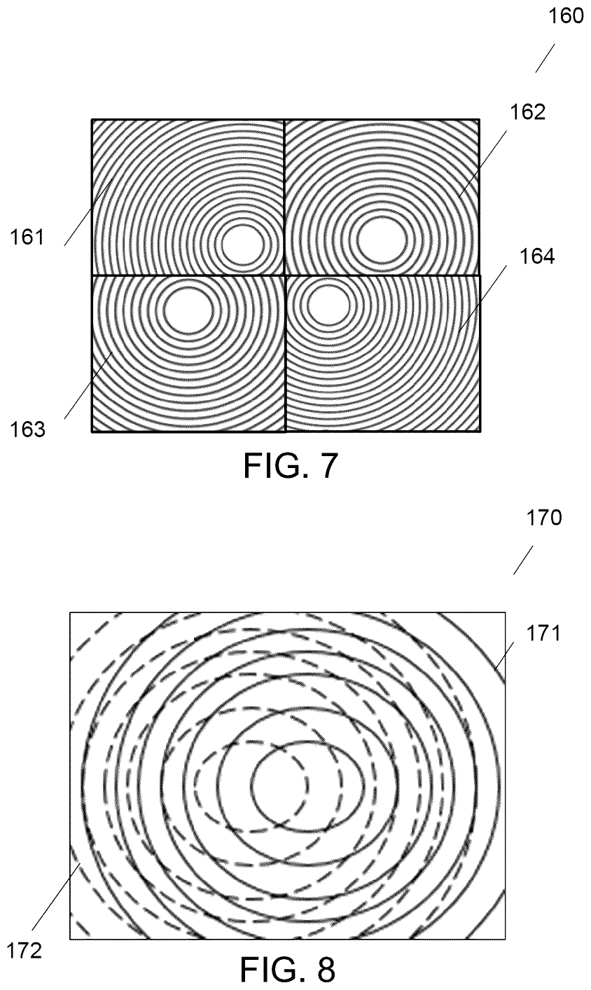

FIG. 6 conceptually illustrates concentric phase fronts (151) formed by a diffractive structure encoding lens power formed on a surface of the reflector substrate. In some embodiments, a reflector can be used to reflect light from one or more transmitters into one or more coverage zones with a separate diffractive structure prescription being provided for each transmitter to receiver path. FIG. 7 conceptually illustrates a set (160) of phase fronts (161-164) formed by a 2×2 array of reflectors, each reflector element being designed to reflect millimeter waves from one or more transmitters into a unique coverage zone. In some embodiments, a reflector comprising more than one reflector prescription can multiplex more than one diffractive structure prescriptions. FIG. 8 conceptually illustrates a set (170) of phase fronts (171,172) each corresponding to a unique beam direction and angular bandwidth formed by a reflector (170) comprising multiplexed diffraction structures (171,172).

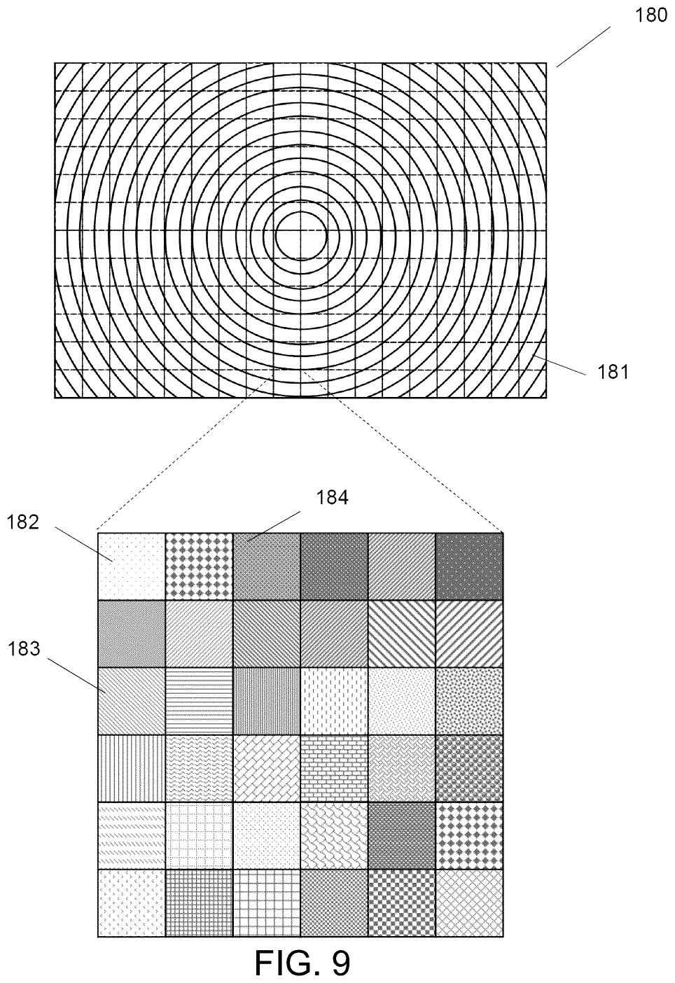

FIG. 9 conceptually illustrates a diffractive structure (180) comprising concentric diffractive structures (181) encoding optical power lensing formed on a surface of the reflector substrate. In some embodiments, which simply deflect the beam without focusing the beam, the diffractive structures can comprise a grid of parallel lines. In some embodiments, the diffractive structures consist of an array of smaller diffractive subcells (182-184). In some embodiments, each diffractive subcell is configured to have a certain reflection amplitude and phase to control the reflected beam wavefronts.

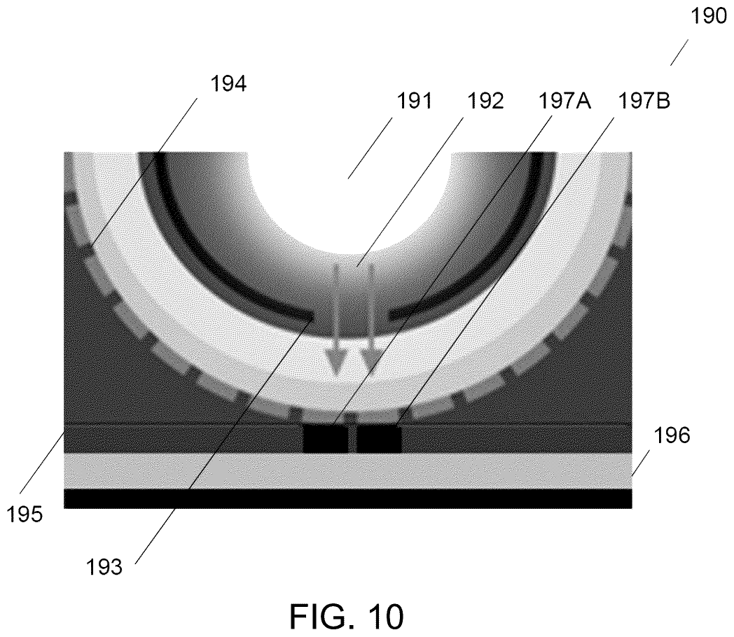

FIG. 10 shows a cylindrical photomask (190) for printing diffractive structures for use in a millimeter wave reflector in accordance with an embodiment of the invention.

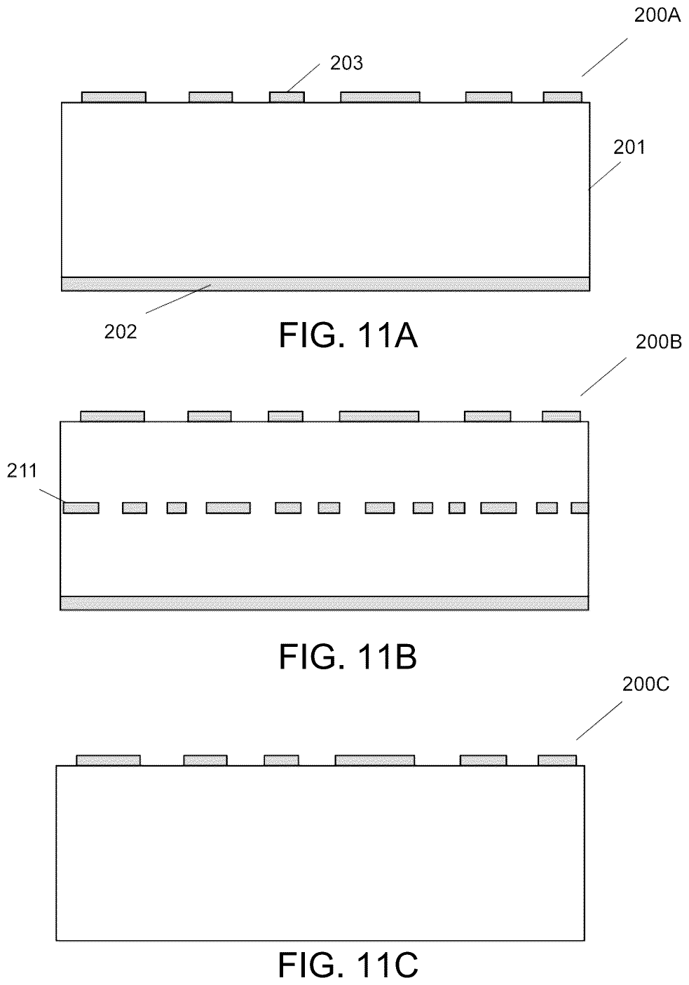

FIGS. 11A, 11B and 11C illustrate different configurations for a diffractive element comprising an array of diffractive subcells. In some embodiments (200A), the diffractive element comprises a dielectric substrate (201) and a ground reflector (202). In some embodiments, diffractive subcells (203) can be configured to reflect at a wider angular bandwidth than the incident beam. In some embodiments (200B) the diffractive subcells and the dielectric substrate thickness are configured to have resonance a particular frequency bandwidth. In some embodiments (200B) there are multiple diffractive array layers, where each layer (211) can be resonant at a particular frequency bandwidth. In some embodiments (200C), there is no reflector layer, and the diffractive element can be configured for transmission inside the building.

An exemplary metallic structure grating technology for use in a diffractive millimeter wave reflector, has been developed by Metamaterials Inc. (Canada). Using this technology, a two-dimensional mesh of continuous metal wires can be fabricated onto any glass or plastic substrate. Metallic structure gratings offer a superior alternative to Indium Tin Oxide (ITO), Silver Nanowire, graphene and carbon nanotube among other ITO-alternative technologies. The design of the mesh geometry allows for a highly conductive and transparent layer. Due to their extremely high conductivity, metallic structure gratings can operate using very little power while remaining clear and transparent. A metallic structure grating includes a grid of highly conductive lines, which allows more energy to pass through an open area surface versus non-patterned conductive materials. The metal mesh is typically created from silver, aluminum, platinum, copper or nickel. However, almost any type of metal can be used, the transparency depending only on the geometrical design of the mesh and not the type of metal. Since the lines are of sub-micron thickness, they are effectively invisible to the human eye. In some cases, the lines can have 500 nm line width with 30-micron pitch. The mesh can be printed on most flexible films such as PET and PC or most substrates such as glass. Currently substrates can be up to 300 mm dimension. Other typical specifications are: sheet resistance: from <1 to 100 Ohm/sq.; transmission: up to 99%; haze: as low as 1%; line-width: from 0.15 to 1 micron; pitch: 2 microns and above; and thickness: 50 nm to 1 micron.

In some embodiments of the invention, a diffracting element for use in a millimeter wave reflector according to the principles of the invention can be a two-dimensional mesh of metal wires. In some embodiments, the metal wires are continuous. In some embodiments the metal wires can have discontinuities.

In some embodiments, nano structures can be fabricated using a process involving rolling a soft cylindrical mask against rigid substrate materials (plates and panels) and rolls of flexible films. Such processes combine the advantages of Soft Lithography and Near-field Optical Lithography, which have both been proven to be reliable in fabrication of nanostructures beyond the diffraction limit. The patterns can be used as etch masks for subsequent etching of the substrate or as masks for nano structuring metals or other functional materials.

FIG. 9 conceptually illustrates one embodiment of a cylindrical photomask (190) for use in the fabrication of a millimeter wave diffractive nanostructure. The apparatus comprises a UV source 191 emitting a UV beam (192) through an aperture 193, an outer layer containing opaque regions and UV transmitting regions. As the cylindrical mask rotates, it comes into contact with regions of the photoresist layer (195) supported by a substrate (196). such that portions of the photoresist (197A,197B) are exposed to the UV beam. A process based on the above apparatus can produce nano structures within metamaterial films that are as small as 175 nanometers. Further layers can be added to the film to increase its functionality. Both positive and negative nanopatterns can be fabricated from the same mask.

Various plasma deposition processes can be used to deposit diffracting structures that can be used in a millimeter wave reflector. One exemplary process uses the Virtual Cathode Deposition (VCD) plasma deposition technique developed by Plasma App, Ltd (United Kingdom), which can provide coatings with high structural and composition control.

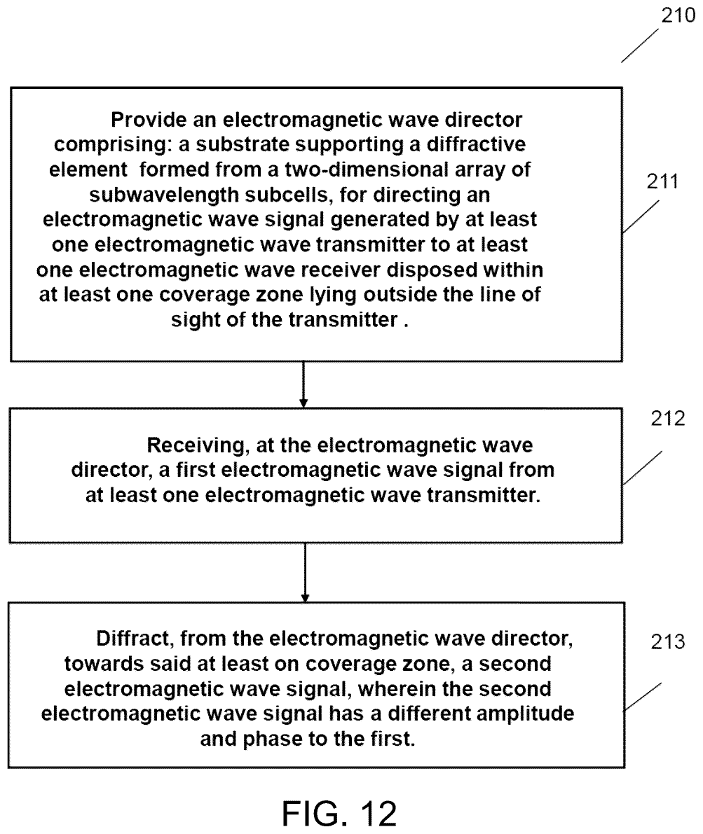

FIG. 12 shows the steps of a method of modifying the amplitude and phase of incident electromagnetic wave wavefronts in accordance with an embodiment of the invention. As shown, the method 210 of modifying the amplitude and phase of incident electromagnetic wave wavefronts is provided. Referring to the flow diagram, method 210 comprises the steps of:
a) providing (211) an electromagnetic wave director comprising a substrate supporting a diffractive element formed from a two-dimensional array of subwavelength subcells deposited onto said substrate, said diffractive element operative to reflect an electromagnetic wave signal generated by at least one electromagnetic wave transmitter to at least one electromagnetic wave receiver disposed within at least one coverage zone lying outside the line of sight of the transmitter,
b) receiving (212) at an electromagnetic wave director, a first electromagnetic wave signal from at least one electromagnetic wave transmitter.
c) diffracting (213) from the electromagnetic wave director, towards said at least one coverage zone, a second electromagnetic wave signal, wherein the second electromagnetic wave signal has a different amplitude and phase to the first.

### EXAMPLES

In some embodiments, the substrate of the millimeter wave reflector can support a ground reflector plane on the opposite side of the substrate to the diffractive element. In some embodiments, the ground reflector plane can be fabricated from a transparent conductive material. In some embodiments, the transparent conductive material can be a metallic wire mesh. In some embodiments the metallic wire mesh can be fabricated using the Rolling Mask Lithography process.

In some embodiments, the diffracting nanostructure can be fabricated using a RML process combined with a VPD process.

In some embodiments, the transparent conductive material can be deposited using a VPD process.

In some embodiments, the reflector can be configured as a film for mounting on a window to provide transmission in the optical wave band and reflection in millimeter wave band.

In some embodiments, the reflector can provide an element of a set of reflectors configured with a set of transmitter antennas to provide a phased array system of the type known as multiple input multiple output (MIMO) antenna system.

In some embodiments, the reflector can incorporate light sensitive elements and light attenuating structures for enabling dimming of visible light transmitted through the reflector.

In some embodiments, the reflector can from part of a system of reflectors that can compensate each other aberrations.

In some embodiments, the reflector can include diffracting structures for enabling at least one of frequency diversity, angle diversity, and polarization diversity.

In some embodiments, the reflector can employ a metasurface configured as a Huygens surface for controlling reflection, beam steering, and polarization.

In addition to the diffractive properties discussed above, in some embodiments, a two-dimensional mesh of nanowires can also provide electromagnetic interference (EMI) shielding. EMI is caused by multiple electromagnetic signals interfering and causing a disturbance, affecting the performance of electronic devices, or even causing damage to the human body. With increased use of electronic devices, there is an elevated density of EMI in the environment. Shielding systems effectively minimize the EMI for applications that require high visible and IR transparency as well as optical clarity. Nanowire solutions offer much better shielding effectiveness than transparent conductive oxides (such as ITO) and existing metallic micro-wire meshes of similar transparency. EMI shielding systems based on conductive oxides have limited performance in shielding due to dopant-density-limited conductivity. Shielding systems based on conventional metallic meshes can have feature sizes of several microns due to the limitations of available fabrication tools, making the mesh visible to the human eye and therefore limiting its use in applications such as windows.

Although RML and VCD are preferred processes for manufacturing the diffractive nanostructures used in the millimeter wave reflector at the time of preparing the present disclosure, other equivalent processes may be used.

Although the present disclosure addresses a millimeter wave reflector, the invention can be applied across the electromagnetic spectrum and in particular to applications in the microwave, radio and infrared bands. The various embodiments discussed above could also be applied to terahertz waves, which are already being considered for future generations of communications systems.

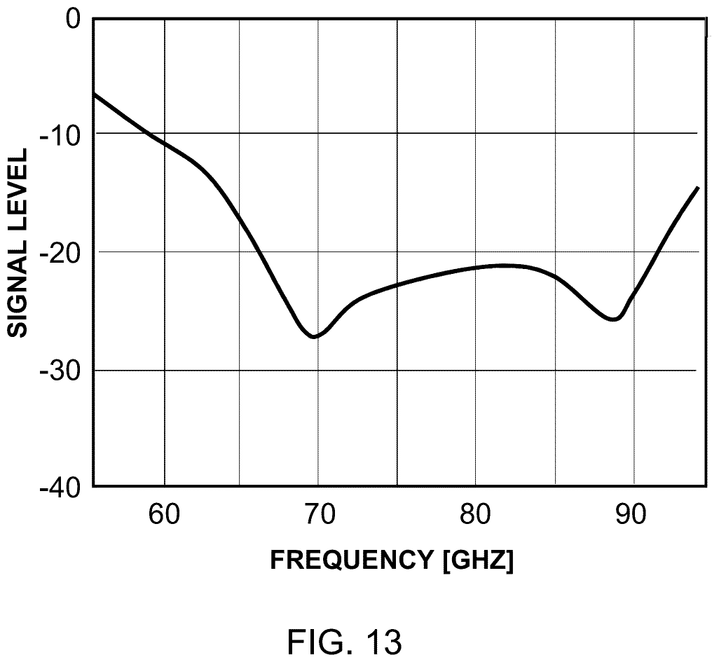

In some embodiments, multi-band operation can be achieved with two or more reflector layers, where the first layer reflects a first frequency and each additional layer reflects a further frequency. In some embodiments the inventors have found that from 6-8 bands can be accommodated in this way. In some embodiments, solutions can be provided for simultaneous 28 GHz 5G and below 6 GHz operation. In some embodiments, operational bandwidth can be increased by producing on the same layer or in two layers complementary resonant frequencies as illustrated in FIG. 13, which illustrates typical measured characteristics for the case where the first resonance is designed for and the second for 90 GHz, imparting a broader bandwidth of around 25 GHz.

Whereas the invention has been described in relation to what are presently considered to be the most practical and preferred embodiments, it is to be understood that the invention is not limited to the disclosed arrangements but rather is intended to cover various modifications and equivalent constructions included within the spirit and scope of the invention. Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-32. (canceled)

33. An electromagnetic wave director comprising:
a diffractive element formed from a two-dimensional array of subwavelength subcells; and
a substrate that supports the diffractive element, wherein the two-dimensional array of subwavelength subcells are deposited onto the substrate, wherein the diffractive element is adapted to direct an electromagnetic wave signal generated by an electromagnetic wave transmitter to an electromagnetic wave receiver disposed within a coverage zone that lies outside a line of sight from the electromagnetic wave transmitter, and wherein the diffractive element has metasurface prescription that modifies amplitude and phase of wavefronts of the electromagnetic wave signal incident onto each of the subwavelength subcells.

34. The electromagnetic wave director of claim 33, wherein the subwavelength subcells are adapted to reflect millimeter waves.

35. The electromagnetic wave director of claim 33, wherein the electromagnetic wave signal is a millimeter wave signal.

36. The electromagnetic wave director of claim 35, wherein the electromagnetic wave signal has a boresight vector, and wherein the electromagnetic wave director is adapted to adjust the boresight vector of the electromagnetic wave signal.

37. The electromagnetic wave director of claim 33, wherein the array of subwavelength subcells is transmissive.

38. The electromagnetic wave director of claim 33, wherein the substrate is made of a substance selected from the group consisting of: glass and plastic.

39. The electromagnetic wave director of claim 33, wherein the diffractive element is disposed on a first side of the substrate, wherein a ground reflector plane is disposed on a second side of the substrate, and wherein the first side is opposite the second side.

40. The electromagnetic wave director of claim 33, further comprising:
a second array of subwavelength subcells disposed within the substrate, wherein the two-dimensional array of subwavelength subcells is spaced apart from the second array of subwavelength subcells so as to be resonant at a predetermined frequency bandwidth.

41. The electromagnetic wave director of claim 33, wherein the electromagnetic wave director is formed as a film adapted to be mounted on a wall of a building.

42. The electromagnetic wave director of claim 33, wherein the diffractive element is transmissive, and wherein the diffractive element is adapted to deflect the electromagnetic wave signal towards the electromagnetic wave receiver disposed inside a building.

43. The electromagnetic wave director of claim 33, wherein the electromagnetic wave director is formed as a film adapted to laminate a window so as to transmit in an optical wave band and to reflect in a millimeter wave band.

44. The electromagnetic wave director of claim 33, wherein the two-dimensional array of subwavelength subcells is a metallic wire mesh.

45. The electromagnetic wave director of claim 33, wherein the two-dimensional array of subwavelength subcells is made using a Virtual Cathode Deposition (VCD) process.

46. A system for modifying the amplitude and phase of electromagnetic wave signals, comprising:
an electromagnetic wave transmitter;
an electromagnetic wave receiver disposed within a coverage zone lying outside a line of sight of the electromagnetic wave transmitter; and
an electromagnetic wave director that includes a substrate and a diffractive element, wherein the diffractive element is a two-dimensional array of subwavelength subcells deposited on the substrate, wherein the diffractive element is adapted to direct an electromagnetic wave signal generated by the electromagnetic wave transmitter to the electromagnetic wave receiver, wherein the electromagnetic wave signal has an amplitude and a phase, and wherein the electromagnetic wave director is adapted to modify the amplitude and the phase of the electromagnetic wave signal.

47. The system of claim 46, wherein the electromagnetic wave director is an active element of a multiple input multiple output (MIMO) beam steering antenna.

48. The system of claim 46, further comprising:
a second electromagnetic wave director, wherein the electromagnetic wave director together with the second electromagnetic wave director provide a folded millimeter wave communication path.

49. A method for modifying amplitude and phase of electromagnetic waves, comprising:
receiving a first electromagnetic wave signal from an electromagnetic wave transmitter;
providing an electromagnetic wave director that includes a substrate and a diffractive element, wherein the diffractive element is a two-dimensional array of subwavelength subcells deposited on the substrate, and wherein the diffractive element is adapted to redirect the first electromagnetic wave signal generated by the electromagnetic wave transmitter; and
diffracting the first electromagnetic wave signal to generate a second electromagnetic wave signal, wherein the second electromagnetic wave signal has an amplitude and a phase that are different than those of the first electromagnetic wave signal, and wherein the diffractive element is adapted to direct the second electromagnetic wave signal towards an electromagnetic wave receiver.

50. The method of claim 49, wherein the second electromagnetic wave signal is a millimeter wave signal.

51. The method of claim 49, wherein the electromagnetic wave director is formed as a film, further comprising:
applying the film to a surface of a building.

52. The method of claim 49, wherein the electromagnetic wave director is formed as a film that is applied to a surface of a building, and wherein the second electromagnetic wave signal is directed towards the electromagnetic wave receiver disposed inside the building.
